(19) United States
(12) Patent Application Publication
(10) Pub. No.: US 2006/0097453 A1
(43) Pub. Date: May 11, 2006

(54) Game controller with force sensing input devices and method of measuring applied forces to game controller input devices to interact with a gaming application

(76) Inventors: Philip Feldman, Catonsville, MD (US); Peter Tsai, Olney, MD (US); Greg Merril, Bethesda, MD (US); Jason Grimm, Owings Mills, MD (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/238,127

(22) Filed: Sep. 29, 2005

Related U.S. Application Data
(63) Continuation-in-part of application No. 10/975,185, filed on Oct. 28, 2004.
Application No. 10/975,185 is a continuation-in-part of application No. 10/806,280, filed on Mar. 23, 2004.
Application No. 10/806,280 is a continuation-in-part of application No. 10/309,565, filed on Dec. 4, 2002.
(60) Provisional application No. 60/514,897, filed on Oct. 29, 2003.
(60) Provisional application No. 60/614,982, filed on Oct. 4, 2004.

(51) Int. Cl. H02J 7/00; A63F 9/20

(52) U.S. Cl. 273/304; 320/114

(57) ABSTRACT

A game controller according tot the present invention employs scalable force-detecting sensors (e.g., strain gauges, etc.) to measure user manipulation of controller input devices (e.g., joysticks, etc.). The controller incorporates force sensing, rather than motion sensing, to provide the “analog” type inputs to a computer-interactive game. The force required to provide the controller output is adjustable by the user, while the mapping of sensor to game control is determined by user configuration of the controller.

### CROSS-REFERENCE TO RELATED APPLICATIONS

This application is a Continuation-In-Part of U.S. patent application Ser. No. 10/975,185, entitled “Configurable Game Controller and Method of Selectively Assigning Game Functions to Controller Input Devices” and filed Oct. 28, 2004, which is a Continuation-In-Part of U.S. patent application Ser. No. 10/806,280, entitled “Game Controller Support Structure and Isometric Exercise System and Method of Facilitating User Exercise During Game Interaction” and filed Mar. 23, 2004, which is a Continuation-In-Part of U.S. patent application Ser. No. 10/309,565, entitled “Computer Interactive Isometric Exercise System and Method for Operatively Interconnecting the Exercise System to a Computer System for Use as a Peripheral” and filed Dec. 4, 2002. Moreover, U.S. patent application Ser. Nos. 10/975,185 and 10/806,280 further claim priority from U.S. Provisional Patent Application Ser. No. 60/514,897, entitled “Configurable Game Controller and Method of Selectively Assigning Game Functions to Controller Input Devices” and filed Oct. 29, 2003. In addition, the present application claims priority from U.S. Provisional Patent Application Ser. No. 60/614,982, entitled “Game Controller with Force Sensing Input Devices and Method of Measuring Applied Forces to Game Controller Input Devices to Interact with a Gaming Application” and filed Oct. 4, 2004. The disclosures of the above-identified patent applications are incorporated herein by reference in their entireties.

### BACKGROUND OF THE INVENTION

1. Technical Field

The present invention pertains to controllers for entertainment systems. In particular, the present invention pertains to game controllers employing force-sensing elements to measure user manipulation of controller input devices (e.g., joysticks, etc.), thereby enabling greater precision and faster response during game play.

2. Discussion of Related Art

Video games, particularly console games (e.g., games that execute on the Sony Playstation, Microsoft XBOX, Nintendo GameCube, etc.), employ controllers that a user manipulates to control the actions of the game software. These actions typically include running, shooting and driving, as well as less conventional behaviors, such as controlling music, rhythm and intensity. The basic controller tends to have two “analog” or movable joysticks for control of behaviors across a continuous range (e.g., steering, etc.) and “analog” or movable buttons for the control of discrete behaviors (e.g., firing a weapon, etc.).

Generally, there are two ways that are used to provide “analog” features in a game controller. One manner is where the user manipulates a mechanism which converts the motion of the device into a varying signal that the game interprets. The other manner includes pressing a button where greater or less pressure results in more or less current passing through a circuit (e.g., typically resulting in a coarse analog signal of two to four increments).

The above-described techniques are not optimal for precise and effective game play. In the case of motion tracking, the requirement of limiting the motion to maintain the reaction time at a sufficient level provides an input that is essentially used more like a button, with the input essentially “buried”. Further, it is difficult for a user to hold a game controller input at a particular angle for any period of time due to the controls inevitably having a light level of resistance to motion.

### OBJECTS AND SUMARY OF THE INVENTION

Accordingly, it is an object of the present invention to employ scalable force-detecting sensors within a game controller for enhanced performance.

It is another object of the present invention to enable users to selectively assign gaming functions to game controller input devices.

Yet another object of the present invention is to employ isometric input devices with configurable actuation resistances within a game controller.

The aforesaid objects may be achieved individually and/or in combination, and it is not intended that the present invention be construed as requiring two or more of the objects to be combined unless expressly required by the claims attached hereto.

According to the present invention, a game controller employs scalable force-detecting sensors (e.g., strain gauges, etc.) to measure user manipulation of controller input devices (e.g., joysticks, etc.). The controller incorporates force sensing, rather than motion sensing, to provide the “analog” type inputs to a computer-interactive game. The force required to provide the controller output is adjustable by the user, while the mapping of sensor to game control is determined by user configuration of the controller.

The present invention controller provides several improvements in performance over a “traditional” controller. Initially, user reaction time is increased since the user no longer needs to move their thumbs. Further, the user can set the amount of force required for a “maximum” behavior due to the amount of force being scalable. This allows for considerably more control. Moreover, the present invention may employ these force-detecting types of sensors for any desired controller input devices (e.g., “analog” joysticks, “analog” buttons, such as triggers, etc.), thereby providing additional high-resolution scalable input.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 is a diagrammatic illustration of a gaming or entertainment system employing a controller with force sensing input devices according to the present invention.

FIG. 2 is a top view in plan of a controller of FIG. 1 employing force sensing input devices according to the present invention.

FIG. 3 is a schematic block diagram of the controller of FIG. 2.

### DETAILED DESCRIPTION OF THE PREFERRED EMBODIMENTS

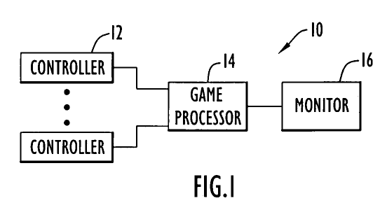

A gaming or entertainment system employing controllers according to the present invention is illustrated in FIG. 1. Specifically, the gaming system includes one or more controllers 12, a game processor 14 and a monitor or display 16. The game processor includes a storage drive and/or unit to receive computer readable media (e.g., CD, DVD, etc.) containing software for various games and a processing device to execute the software to provide games on monitor 16. The game processor may be implemented by any conventional or other processor (e.g., microprocessor, personal computer, video gaming processor, etc.). For example, the game processor may be implemented by conventional video games, such as PS2 available from Sony, XBOX available from Microsoft or GAMECUBE available from Nintendo. The monitor is typically implemented by a conventional television or other display. The games generally include characters or objects that are controlled by a user via controllers 12. For example, the user may control movement and actions of a character or a vehicle (e.g., car, airplane, boat, etc.) to move through a virtual environment displayed on monitor 16. The controllers include a plurality of input devices (e.g., joystick, buttons, etc.) to enable a user to interact with the game. The game processor receives signals from the controllers and updates the display to reflect the movements and/or actions of the character or object as indicated by user manipulation of the controller.

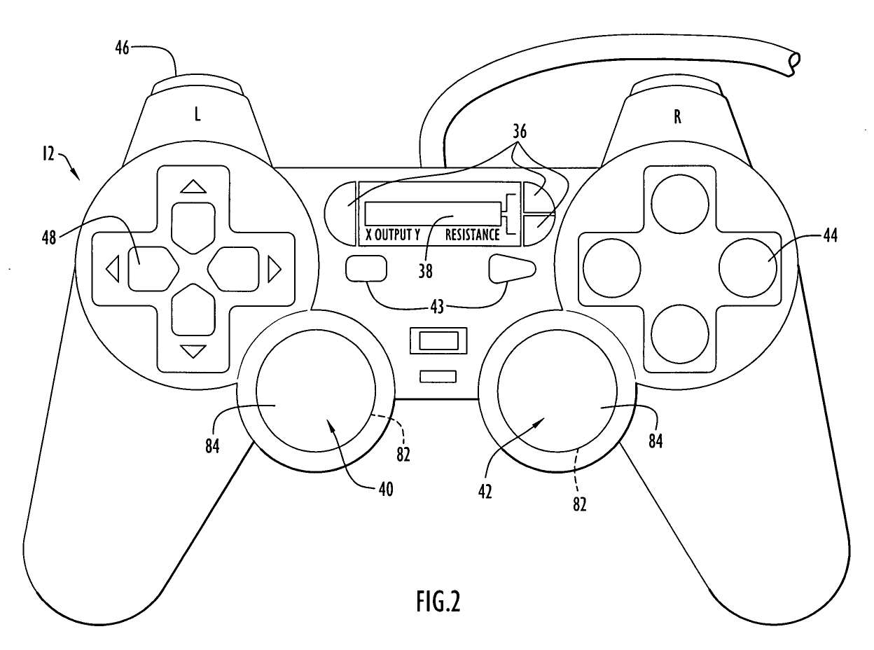

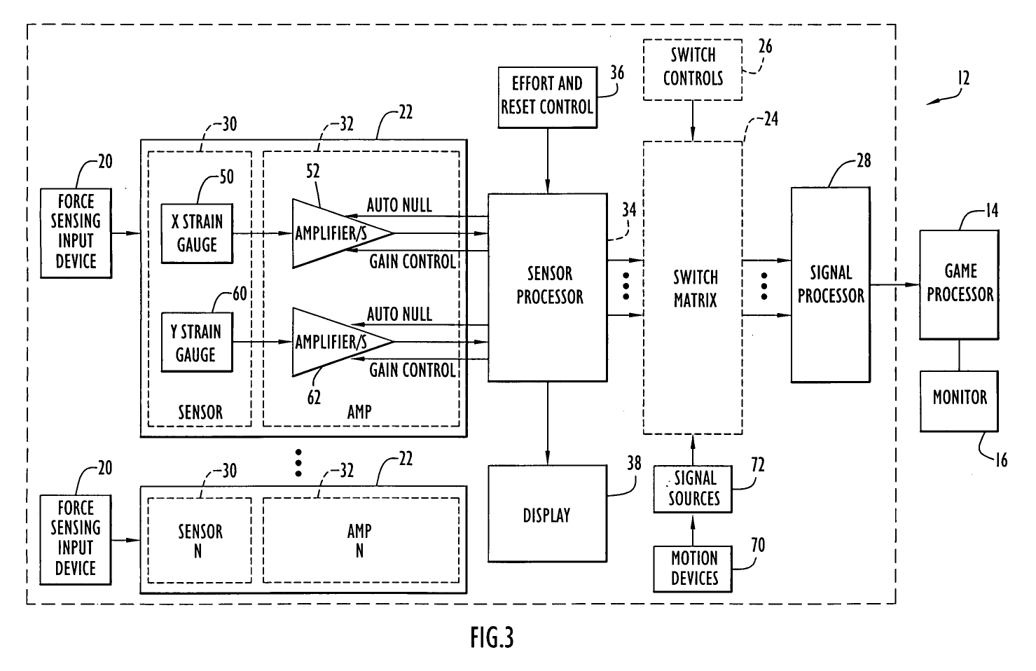

An exemplary controller employing force sensing input devices according to the present invention is illustrated in FIGS. 2-3. Initially, controller 12 may be of the type commonly employed for video games and further includes components to enable measurement of force applied to controller input devices as described below. For example, controller 12 may be of the type used for conventional gaming systems (e.g., PS2, XBOX, GAMECUBE, etc.), such as the type disclosed in U.S. Pat. No. 6,231,444, the disclosure of which is incorporated herein by reference in its entirety. However, the present invention force sensing technique may be applied in a variety of interfaces (e.g., steering wheel type interfaces, rigid gloves, etc.).

Specifically, controller 12 includes force sensing input devices 20, signal sources 22 each associated with a force sensing input device, motion input devices 70, signal sources 72 each associated with a corresponding motion input device, a sensor processor 34, a signal processor 28 and a display 38. A conventional power supply (not shown) provides appropriate power signals to each of the controller components. The controller may be powered by a battery and/or any other suitable power source (e.g., game processor, etc.). A power switch (not shown) may further be included to activate the controller components.

Force sensing input devices 20 and motion input devices 70 are each manipulable by a user to enter information or perform some action within a game. These devices may be any type of conventional or other controller input devices (e.g., button, switch, joystick, etc.). By way of example only, controller 12 includes input devices in the form of joysticks 40, 42, command buttons 43 (e.g., start and select), control buttons 44, trigger buttons 46 and position buttons 48. The controller may include any combination of force sensing input devices 20 and motion input devices 70. By way of example only, joysticks 40, 42 and trigger buttons 46 are implemented as force sensing input devices 20. However, any desired controller input devices may utilize force sensing elements to measure input device manipulation. For example, controller input devices in the form of buttons 43, 44 and/or 48 may be implemented as force sensing input devices.

The force sensing input devices are substantially stationary, where force applied to these devices by a user (or the amount the device is bent or deformed) is measured to determine user manipulation. These types of input devices basically provide an isometric input for the controller. For example, a force sensing joystick may be implemented with a substantially stationary post or actuating member, where user force applied to the joystick or the amount of deformation to the post is measured to determine the user manipulation. The motion input devices are typically those employed within conventional game controllers. These types of input devices are moved in at least one degree of freedom by a user, where the amount of motion is measured or causes an event (e.g., closes a switch, enables contact, etc.) to indicate user manipulation. By way of example, a button may be moved or depressed to close a switch, or motion of a movable joystick may be measured to determine user manipulation of these types of devices.

Controller 12 typically employs signal sources 22, 72 for the force sensing and motion input devices, respectively. With respect to the motion input devices, signal sources 72 may include any conventional or other sensing devices (e.g., switch, contact, variable resistor or potentiometer, etc.) to measure the motion or manipulation of the corresponding motion input device. By way of example only, a motion input device in the form of a button may be associated with a signal source 72 including a contact or switch that closes a circuit in response to button actuation, thereby producing a signal indicating that condition. Further, a motion input device in the form of a movable joystick may have each particular axis of motion be associated with a respective signal source 72 including a variable resistor or potentiometer whose resistance varies in accordance with joystick motion along that axis. Signal source 72 produces a signal indicating a measurement of joystick motion along the corresponding axis. Signal sources 72 are coupled to signal processor 28 to provide information to game processor 14 as described below.

Force sensing input devices 20 are each coupled to a corresponding signal source 22 to produce signals indicating user manipulation of that force sensing input device. The signal source for a force sensing input device includes a force sensor unit 30 and corresponding amplifier unit 32. The signal source basically detects or measures manipulation of the corresponding force sensing input device and produces a signal indicating the measurement or detection. Force sensor unit 30 preferably includes one or more conventional strain gauges, each associated with a corresponding axis of the input device. These sensors measure the amount of a strain deformation applied to the input device as a result of the user applying pushing, pulling or lateral forces to that device. By way of example only, joysticks 40, 42 may each include a substantially stationary post or actuating member 82 with a cap or dome 84 disposed at a post proximal end for receiving force applied by a user. Posts 82 of joysticks 40, 42 each include strain gauges 50, 60 of a corresponding force sensor unit 30. The strain gauges may be disposed at or coupled to any appropriate locations on a joystick post to enable user force applied to that joystick or the amount of deformation to the post to be measured in order to determine the force applied to the joystick by a user. Joysticks 40, 42 may have each particular axis of a joystick post be associated with a respective strain gauge 50 (e.g., X axis), 60 (e.g., Y axis) of a corresponding force sensor unit 30 to measure applied force in accordance with joystick motion or bending along that axis. Sensors 50, 60 of force sensor units 30 are connected to respective amplifiers 52, 62 within corresponding amplifier units 32. The electrical resistance of sensors 50, 60 vary in response to compression and stretching of the corresponding input device or joystick. Amplifiers 52, 62 basically amplify the sensor signals (e.g., in a range compatible with the type of controller employed). The amplified voltage value is sent by each amplifier to sensor processor 34. The force sensor units associated with trigger buttons 46 may each include a single strain gauge since these input devices generally have force applied along a single axis. The force (e.g., a pushing force by the user) applied to the trigger buttons is measured by associated force sensor units 30, amplified by corresponding amplifier units 32 and provided to the sensor processor in substantially the same manner described above.

The signals produced by amplifier units 32 are processed by sensor processor 34. The sensor processor scales the outputs from the amplifier units and sends signals to signal processor 28. The sensor processor may be implemented by any conventional or other processor and typically includes circuitry and/or converts the analog signals from the amplifier units to digital values for processing. Basically, the amplified sensor value represents the force applied by the user, where values toward the range maximum indicate greater applied force. The amplified analog value is digitized or quantized within a range in accordance with the quantity of bits within the converted digital value (e.g., −127 to +127 for eight bits signed, −32,767 to +32,767 for sixteen bits signed, etc.) to indicate the magnitude and/or direction of the applied force. Thus, amplified voltage values toward the range maximum produce digital values toward the maximum values of the quantization ranges.

The sensor processor is connected to display 38 disposed on the controller to facilitate display of information. The sensor processor receives the amplified sensor values and determines various information for display to a user (e.g., the degree of force applied to a particular input device at any given time, the amount of work performed by the user during a particular session, resistance levels, time or elapsed time, force applied to the various axes (X and Y axes), instantaneous force applied, amount of “saturation” of the input device and/or any other related information). The display is preferably implemented by a Liquid Crystal Display (LCD), but may be any type of display (e.g., LED, etc.).

The controller may further be configured to control the level of exertion required by a user for one or more input devices in order to achieve a particular response in the virtual reality or game scenario. The sensor processor receives resistance level and reset controls from the user, where the controller may include display input devices 36 to enter and reset resistance controls and reset clock or other functions. The display input devices are preferably in the form of buttons (e.g., increase and decrease, etc.) for adjusting the amount of effort required to saturate the input devices.

The sensor processor receives the controls from input devices 36, and controls gain parameters of amplifiers within amplifier units 32 to adjust system resistance in accordance with the user specified controls. The user may adjust resistance of input devices individually or collectively. In particular, the sensor processor adjusts the gain control of the appropriate amplifiers within amplifier units 32 in order to facilitate a resistance level in accordance with user input and/or the virtual reality scenario. The gain control parameter basically controls the amount of gain applied by an amplifier to an amplifier input (or force sensor measurement). Since greater amplified values correspond to a greater force, increasing the amplifier gain enables a user to exert less force to achieve a particular amplified force value, thereby effectively lowering the resistance of the input device for the user. Conversely, reducing the amplifier gain requires a user to exert greater force to achieve the particular amplified force value, thereby increasing the resistance of the input device for the user. The sensor processor further adjusts an amplifier Auto Null parameter to zero or tare the corresponding strain gauge sensors. Alternatively, or in combination with user input, the resistance levels may be controlled by the sensor processor based upon conditions within the virtual reality or game scenario, such as changing wind conditions, changing grade of the terrain (e.g., going uphill), etc. In addition, the sensor processor resets various parameters (e.g., resistance, time, work, etc.) in accordance with reset controls received from input devices 36.

The signals produced by sensor processor 34 and signal sources 72 associated with motion input devices 70 are processed by signal processor 28. The signal processor may be in the form of game processor 14 (FIG. 1), or may be implemented by any conventional or other processor and typically includes circuitry and/or converts the analog signals from signal sources 72 to digital values for processing. The inputs of signal processor 28 are conventionally coupled in a fixed manner to specific controller input devices. Thus, the signal processor or game processor knows the controller input device associated with each input and maps game functions to those inputs (or controller input devices) in accordance with the assignments within the game software.

The signals from the sensor processor and signal sources 72 are transmitted to a respective predetermined memory location within signal processor 28. The signal processor samples the memory locations at predetermined time intervals (e.g., preferably on the order of ten milliseconds or less) to continuously process and send information to the game processor to update and/or respond to an executing gaming application.

Basically, the signal processor processes and arranges the sensor processor and motion input device signals into suitable data packets for transmission to the game processor. The signal processor may process raw digital values in any fashion to account for various calibrations or to properly adjust the values within quantization ranges. The data packets are in a format resembling data input from a standard peripheral device (e.g., game controller, etc.). For example, the processor may construct a data packet that includes the status of all controller input devices (e.g., joysticks 40,42, buttons 43,44,46, 48, etc.) and the values of each sensor. By way of example only, the data packet may include header information, X-axis information indicating a corresponding sensor force and joystick measurement along this axis, Y-axis information indicating a corresponding sensor force and joystick measurement along this axis, rudder or steering information, throttle or rate information and additional information relating to the status of input devices (e.g., buttons, etc.). Additional packet locations may be associated with data received from controller or other input devices connected with the signal processor, where the input devices represent additional operational criteria for the scenario (e.g., the firing of a weapon in the scenario when the user presses an input button, throttle, etc.). The game processor processes the information or data packets in substantially the same manner as that for information received from a conventional peripheral (e.g., game controller, etc.) to update and/or respond to an executing gaming application (e.g., game, etc.).

The controller of the present invention may further enable a user to selectively assign game functions to input devices. Generally, software written for use with conventional controllers including multiple joysticks assign different functions to each joystick axis. For example, a driving game may have the forward and backward motion of a right joystick simulate the accelerator function in a car, while the left and right motion of the left joystick may simulate the functions of the car steering wheel. Although the choices of the software designer for assigning functions to the joystick control are generally acceptable, there are situations where the choices need improvement. By way of example, there may be situations where a person can only use one hand. Thus, this person will have to switch between joysticks in the above example to control car movement, thereby making the game much less enjoyable and much more difficult to achieve a high performance in the game.

Accordingly, the controller of the present invention may further enable controller input devices (e.g., buttons, switches, joysticks, etc.) to be selectively assigned to game functions. With reference to the above driving example, if the game functions associated with the left and right motions of the left joystick are assigned to the right joystick, the right joystick can be used to both steer the car and serve as the car accelerator. Thus, a game that was designed to be played with two hands is now playable with one hand.

In order to selectively configure controller 12 for game functions, the controller may further include switching device 24 and switch control unit 26. The switching device basically enables information for controller input devices to be selectively placed on signal processor inputs corresponding to the desired game functions. For example, gaming software may assign a car accelerator function to controller left joystick 40 (e.g., as viewed in FIG. 2) and maps that function to a particular signal processor input expecting information from the left joystick. However, the switching matrix may couple signal source 22 of right joystick 42 (e.g., as viewed in FIG. 2) to that signal processor input, where the game processor processes the right joystick information for the accelerator function, thereby enabling the right joystick to perform that function. Thus, the controller input devices may be selectively assigned to game functions absent knowledge by the gaming software.

The switching device receives information from sensor processor 34 and signal sources 72 associated with motion input devices 70 and is coupled to the inputs of signal processor 28. The switching device may be implemented in hardware and/or software by any conventional or other devices capable of switching signals (e.g., switches, multiplexers, processors, cross-bar switches, switching matrix, gate arrays, logic, relays, etc.). The particular switching device embodiment utilized may depend upon the number of controller input devices and level of function assignment or blending desired. For example, in order to exchange functions between joysticks 40, 42 each with motion along an axis (e.g., to swap left-right joystick motion corresponding to a steering function or forward and backward joystick motion corresponding to an accelerator function), two double pole double throw switches may be utilized. The switches basically couple the signal sources of the joysticks (e.g., strain gauges measuring manipulation along the axis) to the signal processor inputs corresponding to the desired functions. Thus, the functions of each joystick may be performed by the other (e.g., swapped) or one joystick may perform both functions (e.g., steering and accelerator) in accordance with the connections (e.g., measurements along respective axes of the joystick may be supplied to the appropriate signal processor inputs for the corresponding functions). Applications of higher complexity with respect to blending functions may require additional selector switches and various combinations of selector switch settings.

The switching device may be implemented by devices that can switch signals in the analog and/or digital domain, and may include a converter to convert analog signals to digital signals. For example, the switching device may be implemented by a processor or router that receives signals from the sensor processor and signal sources 72 (e.g., converting the analog signals to digital signals to enable switching of all digital signals) and directs the signals to the signal processor inputs corresponding to the desired functions. These tasks may be accomplished in software. The switching device switches signals in accordance with controls from a switch control unit 26. The switch control unit may include one or more controls disposed on controller 12, where the controls are manipulable by a user to configure the switching device. Alternatively, the switch control unit may include a control processor to control the switching device in accordance with the controls to achieve the desired function assignment. The switch controls may be implemented by any conventional or other input devices (e.g., buttons, keys, slides, etc.) to provide control signals to the switching device or control processor.

The switching device or switch control unit may alternatively provide a user interface to enable the user to enter information to configure the controller in the desired manner. The interface may be in the form of screens on a controller display or controller lights or other indicators. Further, the interface may be shown on display 16 and implemented by game processor 14. The switch control unit receives the configuration information entered by a user and controls switching device 24 to provide the appropriate signals to signal processor 28 to attain the desired configuration or function assignment.

Operation of system 10 is described with reference to FIGS. 1-3. Initially, the user couples controller 12 to game processor 14 and may selectively assign game functions to the joystick and other controller input devices as described above. A game is selected and executed on the game processor, and the user manipulates the controller input devices to interact with the game. The user applies one or more forces to the force sensing input devices (e.g., joysticks 40, 42 and trigger buttons 46) so as to effect corresponding movement, for example, of a character or an object in the scenario displayed by the game processor. The user may further manipulate the motion (e.g., buttons 43, 44 and/or 48) or other controller input devices for additional actions or controls depending upon the particular game.

The signals from signal sources 22 are processed by sensor processor 34. The sensor processor may display various information on display 38 and/or adjust resistance levels of the force sensing input devices as described above. The signals from the sensor processor and signal sources 72 are transmitted to signal processor 28 (e.g., via switching device 24 in the case of a configurable controller) as described above. The signal processor generates the data packets for transference to game processor 14. The game processor processes the information or data packets in substantially the same manner as that for information received from a conventional peripheral (e.g., game controller, etc.) to update and/or respond to an executing gaming application. Thus, the force applied by the user to the force sensing input devices results in a corresponding coordinate movement or action in the scenario displayed on display 16.

It will be appreciated that the embodiments described above and illustrated in the drawings represent only a few of the many ways of implementing a game controller with force sensing input devices and method of measuring applied forces to game controller input devices to interact with a gaming application.

The controller may be of any shape or size, may be constructed of any suitable materials, and may be of the type of any commercially available or other game controller (e.g., those for use with PS2, XBOX, GAMECUBE, etc.). The controller may include any quantity of any types of input devices (e.g., buttons, slides, joysticks, track type balls, etc.) disposed at any locations and arranged in any fashion. The controller may include any quantity of any types of signal source devices to generate signals in accordance with force sensing or motion input device manipulation (e.g., variable resistors or potentiometers, switches, contacts, relays, sensors, strain gauges, etc.). The signal sources may correspond with any quantity of axes for an input device. Any controller input devices may be implemented as force sensing devices, while the controller input devices may be assigned to any suitable game functions by the switching device. The controller may include any quantity or combination of force sensing input devices and motion input devices.

The switching matrix or device may be implemented by any quantity of any conventional or other devices capable of switching signals (e.g., switches, multiplexers, cross-bar switch, analog switches, digital switches, routers, logic, gate arrays, logic arrays, etc.). The switching controls or switch control unit may be implemented by any conventional or other control or input devices (e.g., processor, slides, switches, buttons, etc.). The control processor may be implemented by any conventional or other processor or circuitry (e.g., microprocessor, controller, etc.). The switching devices may direct signals from any quantity of inputs to any quantity of outputs in accordance with user-specified or other controls and may map any controller input devices to any suitable game functions. The switching device may be disposed internal or external of the controller.

The game processor may be implemented by any quantity of any personal or other type of computer or processing system (e.g., IBM-compatible, Apple, Macintosh, laptop, palm pilot, microprocessor, gaming consoles such as the Xbox system from Microsoft Corporation, the Play Station 2 system from Sony Corporation, the GameCube system from Nintendo of America, Inc., etc.). The game processor may be a dedicated processor or a general purpose computer system (e.g., personal computer, etc.) with any commercially available operating system (e.g., Windows, OS/2, Unix, Linux, etc.) and/or commercially available and/or custom software (e.g., communications software, application software, etc.) and any types of input devices (e.g., keyboard, mouse, microphone, etc.). The game processor may execute software from a recorded medium (e.g., hard disk, memory device, CD, DVD or other disks, etc.) or from a network or other connection (e.g., from the Internet or other network).

The force sensing input devices may be constructed of any suitable materials that preferably are subject to measurable deflection within an elastic limit of the materials when subjected to one or more straining or other forces by the user. Any suitable number of any types of sensors (e.g., strain gauges, etc.) may be applied to a force sensing input device to facilitate the measurement of any one or more types of strain or other forces applied by the user (e.g., bending forces, twisting forces, compression forces and/or tension forces). The sensors may be constructed of any suitable materials, may be disposed at any locations and may be of any suitable type (e.g., strain gauge, etc.). Further, the sensors may include any electrical, mechanical or chemical properties that vary in a measurable manner in response to applied force to measure force applied to an object.

The processors (e.g., control, sensor, signal, game, switching devices, etc.) may be implemented by any quantity of any type of microprocessor, processing system or other circuitry. The signal processor may be connected to one or more game processors or host computer systems via any suitable peripheral, communications media or other port of those systems. The signal processor may further arrange digital data representing force measurements by sensors and other controller information into any suitable data packet format that is recognizable by the game processor or host computer system receiving data packets from the signal processor. The data packets may be of any desired length, include any desired information and be arranged in any desired format.

The signal processor may sample the information at any desired sampling rate (e.g., seconds, milliseconds, microseconds, etc.), or receive measurement values or other information in response to interrupts. The analog values (e.g., from signal sources 22, 72) may be converted to digital values having any desired quantity of bits or resolution. The conversion may be performed by any conventional or other circuitry (e.g., A/D converter, etc.) external to or within any controller components (e.g., signal sources 22, 72, switching device, sensor processor, signal processor, game processor, etc.). The processors (e.g., control, signal, sensor, etc.) may process raw digital values in any desired fashion to produce information for transference to the display, game processor or host computer system. This information is typically dependent upon a particular application. The correlation between the measured force and provided value for that force may be determined in any desired fashion. By way of example, the amplified measurement range may be divided into units corresponding to the resolution of the digital value. For an eight bit unsigned digital value (e.g., where the value indicates the magnitude of force), each increment represents 1/256 of the voltage range. With respect to a five volt range, each increment is 5/256 of a volt, which is approximately 0.02 volts. Thus, for an amplified force measurement of three volts, the digital value may correspond to approximately 150 (i.e., 3.0/0.2).

Any suitable number of any types of conventional or other circuitry may be utilized to implement the amplifiers, sensors, switching device and processors (e.g., sensor, control, signal, etc.). The amplifiers may produce an amplified value in any desired voltage range, while the A/D conversion may produce a digitized value having any desired resolution or quantity of bits (e.g., signed or unsigned). The controller may include any quantity of the above or other components arranged in any fashion. The resistance change of the sensors may be determined in any manner via any suitable conventional or other circuitry. The amplifiers and processors (e.g., sensor, signal, etc.) may be separate or integrated as a single unit. Any suitable number of any type of conventional or other displays may be connected to the processors (e.g., sensor, signal, control, game, etc.) to provide any type of information relating to a particular computer session. A display may be located at any suitable location on or remote from the controller.

The resistance level may be controlled by adjusting amplifier or other parameters. Alternatively, the resistance level may be controlled based on thresholds entered by a user. For example, the processors (e.g., sensor and/or signal processors) may be configured to require a threshold resistance level be achieved, which is proportionate to the amount of straining force applied by the user to one or more input devices, before assigning appropriate data values to the data packets to be sent to the game processor or host computer. Threshold values for the change in strain gauge resistance may be input to the processor by the user via an appropriate input device (e.g., a keypad).

It is to be understood that the software of the processors (e.g., control, sensor, game, signal, switching devices, etc.) may be implemented in any desired computer language, and could be developed by one of ordinary skill in the computer and/or programming arts based on the functional description contained herein. Further, any references herein of software performing various functions generally refer to computer systems or processors performing those functions under software control. The processors (e.g., control, sensor, signal, switching device, etc.) may alternatively be implemented by hardware or other processing circuitry, or may be implemented on the game processor or host system as software and/or hardware modules receiving the sensor and/or input device information or signals. The various functions of the processors (e.g., control, sensor, signal, game, switching devices, etc.) may be distributed in any manner among any quantity (e.g., one or more) of hardware and/or software modules or units, processors, computer or processing systems or circuitry, where the processors, computer or processing systems or circuitry may be disposed locally or remotely of each other and communicate via any suitable communications medium (e.g., LAN, WAN, Intranet, Internet, hardwire, modem connection, wireless, etc.). The software and/or algorithms described above may be modified in any manner that accomplishes the functions described herein.

The terms “upward”, “downward”, “top”, “bottom”, “side”, “front”, “rear”, “upper”, “lower”, “vertical”, “horizontal”, “height”, “width”, “length”, “forward, “backward”, “left”, “right” and the like are used herein merely to describe points of reference and do not limit the present invention to any specific orientation or configuration.

The present invention controller is not limited to the gaming applications described above, but may be utilized as a peripheral for any processing system, software or application. For example, the present invention controller may be utilized with the exercise systems disclosed in the aforementioned patent applications.

From the foregoing description, it will be appreciated that the invention makes available a novel game controller with force sensing input devices and method of measuring applied forces to game controller input devices to interact with a gaming application, wherein a game controller employs force-sensing elements to measure user manipulation of controller input devices (e.g., joysticks, etc.), thereby enabling greater precision and faster response during game play.

Having described preferred embodiments of a new and improved game controller with force sensing input devices and method of measuring applied forces to game controller input devices to interact with a gaming application, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A game controller to interact with a game processor including a gaming application comprising:
a plurality of user-manipulable input devices including at least one isometric input device, wherein an amount of applied force for actuation of said at least one isometric input device is configurable by a user; and
a plurality of signal sources each to detect manipulation of a corresponding input device and to generate a manipulation signal indicating said measured manipulation to enable control of a corresponding gaming application function.

2. The game controller of claim 1, wherein said input devices include at least one of joysticks, buttons and switches.

3. The game controller of claim 1, wherein said signal source associated with said at least one isometric input device includes:
a sensor unit to determine said force applied to a corresponding isometric input device; and
an amplification unit to receive and amplify signals from said sensor unit for processing.

4. The game controller of claim 3, wherein said sensor unit includes at least one strain gauge.

5. The game controller of claim 1 further including:
a controller processor to receive and process said manipulation signals from said signal sources and transfer information to said game processor in a format compatible with said game processor for controlling said gaming application functions.

6. The game controller of claim 5, wherein said controller processor includes a plurality of inputs each associated with a corresponding gaming application function and receiving a manipulation signal from a corresponding input device.

7. The game controller of claim 6 further including:
a configuration module to assign said gaming application functions to said input devices in accordance with device function assignments received from said user.

8. The game controller of claim 7, wherein said configuration module includes:
a switching device coupled to said signal sources and said controller processor to direct said manipulation signals from said signal sources to controller processor inputs in accordance with said device function assignments from said user to assign said input devices to said gaming application functions.

9. The game controller of claim 8 further including:
a switch control unit to enable entry of said device function assignments from said user and to control said switching device to direct said manipulation signals from said signal sources to controller processor inputs in accordance with said device function assignments.

10. The game controller of claim 8, wherein said configuration module further includes a user interface to enable entry of said device function assignments and to control said switching device to direct said manipulation signals from said signal sources to controller processor inputs in accordance with said device function assignments.

11. The game controller of claim 1, wherein said game controller is disposed within an exercise system.

12. The game controller of claim 1 further including:
a force input device to enable entry of said amount of force that must be applied by said user to actuate said at least one isometric input device.

13. The game controller of claim 5 further including:
a display controlled by said controller processor to output information relating to manipulation of said at least one isometric input device.

14. The game controller of claim 13, wherein said controller processor further determines an amount of work applied by said user to said at least one isometric input device for a selected period of time and controls said display to output information relating to the amount of work applied by said user.

15. A game controller to interact with a game processor including a gaming application comprising:
a plurality of user-manipulable input devices including at least one isometric input device;
a plurality of signal sources each to detect manipulation of a corresponding input device and to generate a manipulation signal indicating said measured manipulation to enable control of a corresponding gaming application function;
a controller processor to receive and process said manipulation signals from said signal sources and transfer information to said game processor in a format compatible with said game processor for controlling said gaming application functions; and
a configuration module to assign said gaming application functions to said input devices in accordance with device function assignments received from said user.

16. The game controller of claim 15, wherein said configuration module includes:
a switching device coupled to said signal sources and said controller processor to direct said manipulation signals from said signal sources to controller processor inputs in accordance with said device function assignments from said user to assign said input devices to said gaming application functions.

17. The game controller of claim 16 further including:
a switch control unit to enable entry of said device function assignments from said user and to control said switching device to direct said manipulation signals from said signal sources to controller processor inputs in accordance with said device function assignments.

18. The game controller of claim 16, wherein said configuration module further includes a user interface to enable entry of said device function assignments and to control said switching device to direct said manipulation signals from said signal sources to controller processor inputs in accordance with said device function assignments.

19. The game controller of claim 15, wherein said game controller is disposed within an exercise system.

20. A method of configuring a game controller to interact with a game processor including a gaming application, wherein said game controller includes a plurality of user-manipulable input devices with at least one isometric input device, and a plurality of signal sources each associated with a corresponding input device to detect manipulation of that device, said method comprising:
(a) receiving an amount of applied force for actuation of said at least one isometric input device from a user and configuring said game controller in accordance with said force amount; and
(b) detecting manipulation of an input device and generating a manipulation signal indicating said measured manipulation to enable control of a corresponding gaming application function.

21. The method of claim 20, wherein said input devices include at least one of joysticks, buttons and switches.

22. The method of claim 20, wherein step (b) further includes:
(b.1) determining said force applied to a corresponding isometric input device via at least one sensor; and
(b.2) amplifying signals from said at least one sensor for processing.

23. The method of claim 22, wherein said at least one sensor includes at least one strain gauge.

24. The method of claim 20, wherein said game controller further includes a controller processor with a plurality of inputs each associated with a corresponding gaming application function and receiving a manipulation signal from a corresponding input device, and said method further includes:
(c) receiving and processing said manipulation signals and transferring information to said game processor in a format compatible with said game processor to control said gaming application functions.

25. The method of claim 24, wherein step (c) further includes:
(c.1) receiving device function assignments from a user; and
(c.2) assigning said gaming application functions to said input devices in accordance with said device function assignments.

26. The method of claim 25, wherein step (c.2) further includes:
(c.2.1) directing said manipulation signals to controller processor inputs, via a switching device, in accordance with said device function assignments from said user to assign said input devices to said gaming application functions.

27. The method of claim 26, wherein step (c.1) further includes:
(c.1.1) receiving said device function assignments from said user via a switch control unit; and
step (c.2.1) further includes:
(c.2.1.1) controlling said switching device to direct said manipulation signals to controller processor inputs in accordance with said device function assignments.

28. The method of claim 26, wherein step (c.1) further includes:
(c.1.1) receiving said device function assignments from said user via a user interface; and
step (c.2.1) further includes:
(c.2.1.1) controlling said switching device to direct said manipulation signals to signal processor inputs in accordance with said device function assignments.

29. The method of claim 20, wherein said game controller is disposed within an exercise system.

30. The method of claim 20, wherein step (a) includes:
(a.1) facilitating user entry of said amount of force that must be applied by said user to actuate said at least one isometric input device.

31. The method of claim 24, wherein step (c) further includes:
(c.1) displaying information relating to manipulation of said at least one isometric input device.

32. The method of claim 31, wherein step (c.1) further includes:
(c.1.1) determining an amount of work applied by said user to said at least one isometric input device for a selected period of time and displaying information relating to the amount of work applied by said user.

33. A method of configuring a game controller to interact with a game processor including a gaming application, wherein said game controller includes a plurality of user-manipulable input devices, a plurality of signal sources each associated with a corresponding input device to detect manipulation of that device, and a controller processor with a plurality of inputs each associated with a corresponding gaming application function and receiving a manipulation signal from a corresponding input device, said method comprising:
(a) receiving device function assignments from a user, wherein said plurality of user-manipulable input devices includes at least one isometric input device;
(b) assigning said gaming application functions to said input devices in accordance with said device function assignments;
(c) detecting manipulation of an input device and generating a manipulation signal indicating said measured manipulation to enable control of a corresponding gaming application function; and
(d) processing said manipulation signals and transferring information from said controller processor to said game processor in a format compatible with said game processor to control said gaming application functions.

34. The method of claim 33, wherein step (d) further includes:
(d.1) directing said manipulation signals to controller processor inputs, via a switching device, in accordance with said device function assignments from said user to assign said input devices to said gaming application functions.

35. The method of claim 34, wherein step (a) further includes:
(a.1) receiving said device function assignments from said user via a switch control unit; and
step (d.1) further includes:
(d.1.1) controlling said switching device to direct said manipulation signals to controller processor inputs in accordance with said device function assignments.

36. The method of claim 34, wherein step (a) further includes:
(a.1) receiving said device function assignments from said user via a user interface; and
step (d.1) further includes:
(d.1.1) controlling said switching device to direct said manipulation signals to signal processor inputs in accordance with said device function assignments.

37. The method of claim 33, wherein said game controller is disposed within an exercise system.
